(19) United States
(12) Patent Application Publication
(10) Pub. No.: US 2026/0295761 A1
(43) Pub. Date: Oct. 1, 2026

(54) ELECTRONIC DEVICE MID-FRAME POLISHING APPARATUS

(71) Applicant: Communications Test Design, Inc., West Chester, PA (US)

(72) Inventors: Brian KENNEY, West Chester, PA (US); Chris MANDEEN, West Chester, PA (US); Robel TADELE, West Chester, PA (US); Christina DEBARBERIE, West Chester, PA (US); Kartik R. PATEL, Coatesville, PA (US); Ryan SMITH, Boothwyn, PA (US)

(73) Assignee: Communications Test Design, Inc., West Chester, PA (US)

(21) Appl. No.: 19/089,361

(22) Filed: Mar. 25, 2025

(51) Int. Cl. B24B 29/02; B25J 11/00

(52) U.S. Cl. CPC B24B 29/02; B25J 11/0065

(57) ABSTRACT

An electronic device mid-frame polishing apparatus is shown and described. The electronic device mid-frame polishing apparatus includes a frame which supports a robot arm and a polishing setup. The robot arm is configured to place an electronic device into the polishing setup. The frame supports at least one computer. The robot arm is operably coupled with the computer. The polishing setup is operably coupled with the computer.

### BACKGROUND OF THE INVENTION

Technology is always advancing and has done so at a rapid pace for the last several decades. Technology has become sophisticated, smaller, and accessible across the globe. This has led to technology becoming integral in everyday life. As with any integral element of life, the demand is high. This high demand has led to a rise in the cost of technological devices.

In addition to high demand, the simple replacement of devices can be expensive. If one merely discards older equipment or equipment with minor defects for a brand-new piece the cost can escalate quickly. If, however, technology is upgraded, or repaired this process can be much more cost effective for both the company and consumer.

One of the things which can cause an electronic device to have a lessor value are scratches. In many instances if an electronic device is not kept in a case the mid-frame can become damaged and scratched. Even superficial scratches can cause significant devaluation. In some instances, an electronic device can be refinished to remove scratched or imperfections in the coloring.

The process of removing scratches leads to removing of the mid-frame coloring and the need to recolor the mid-frame. In order to have an electronic device look like it has a factory finish, the mid-frame has to have an extremely smooth finish. In many instances the best way to create the proper texturing is to polish the mid-frame. This can be an extremely time consuming process.

Many companies have been taking advantage of the repair instead of discard philosophy. Further, many consumers are happy purchasing a lightly used and repaired device instead of a brand new one. However, these processes come with new challenges in order to remain effective. Consequently, there is always a need for an improvement in the art.

### SUMMARY OF THE INVENTION

The present invention provides an electronic device mid-frame polishing apparatus wherein the same can be utilized for providing convenience for the user when needing to create a smooth texture for recoloring on a mid-frame. The electronic device mid-frame polishing apparatus includes a frame which supports a robot arm and a polishing setup. The robot arm is configured to place an electronic device into the polishing setup. The frame supports at least one computer. The robot arm is operably coupled with the computer. The polishing setup is operably coupled with the computer.

Another object of the electronic device mid-frame polishing apparatus is to have a planar surface, wherein the robot arm and the polishing setup are mounted to the planar surface.

Another object of the electronic device mid-frame polishing apparatus is to have a device holder mounted to the planar surface.

Another object of the electronic device mid-frame polishing apparatus is to have the device holder be positioned within reach of the robot arm.

Another object of the electronic device mid-frame polishing apparatus is to have the device holder be comprised of a planar surface having a plurality of sidewalls rising therefrom. The planar surface has at least one cutaway section.

Another object of the electronic device mid-frame polishing apparatus is to have the robot arm have a toolhead attached to one end.

Another object of the electronic device mid-frame polishing apparatus is to have the tool head be a vacuum assembly configured to pick up and hold an electronic device.

Another object of the electronic device mid-frame polishing apparatus is to have the polishing setup be comprised of an actuator, a motor, and a tool head.

Another object of the electronic device mid-frame polishing apparatus is to have a vacuum pump and a vacuum regulator secured to the frame.

Other objects, features and advantages of the present invention will become apparent from the following detailed description taken in conjunction with the accompanying drawings.

### BRIEF DESCRIPTION OF THE DRAWINGS

The accompanying drawings are incorporated in and are to be considered part of the present specification. These drawings are meant to aid the reader's understanding and comprehension of the present disclosure and are depictions of various example embodiments. The drawings are not to be considered limiting upon the disclosure. It should specifically be noted that the drawings are examples and may not necessarily be drawn to scale.

FIG. 1 shows a block diagram of a computing system.

FIG. 2A shows a front view of an example of a mobile phone device.

FIG. 2B shows a rear view of an example of a mobile phone device.

FIG. 3A shows a side view of an embodiment of an electronic device mid-frame polishing apparatus

FIG. 3B shows a perspective view of an embodiment of the electronic device mid-frame polishing apparatus.

FIG. 4 shows a side perspective view of a device holder for the electronic device mid-frame polishing apparatus.

FIG. 5 shows a front view of an embodiment of the electronic device holder for the electronic device mid-frame polishing apparatus.

FIG. 6 shows a flow chart of one embodiment of a method for using the electronic device mid-frame polishing apparatus.

### DETAILED DESCRIPTION OF THE INVENTION

For the purposes of presenting a brief and clear description of the present invention, a preferred embodiment will be discussed as used for the electronic device mid-frame polishing apparatus. The figures are intended for representative purposes only and should not be considered to be limiting in any respect.

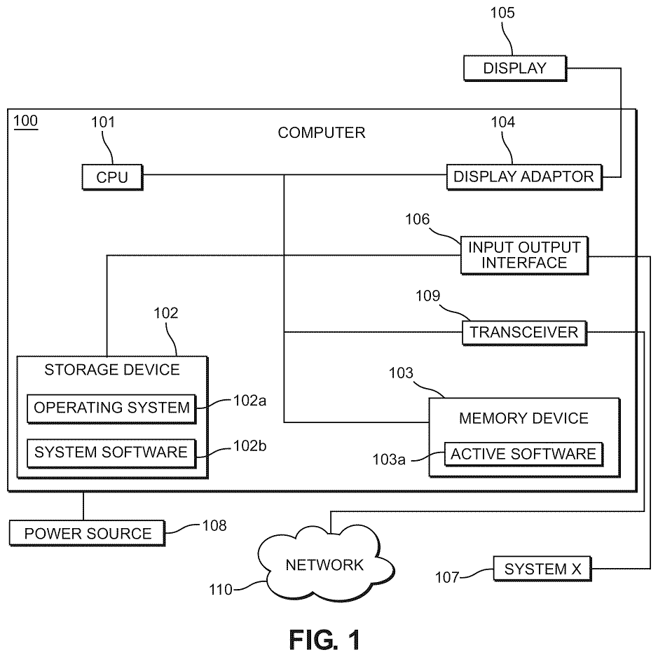

Referring now to FIG. 1, there is shown a block diagram of a computing system. Computing systems may have many interchangeable parts or multiples of some parts. One of ordinary skill in the art will understand that the shown computer 100 is a basic computing system demonstrating a minimal amount of parts to allow for the computer to function. Computer 100 is exemplary, and one of ordinary skill in the art will recognize that computer 100 may be altered as necessary to render the presently disclosed system operable or to provide a peak performance of the disclosed system.

The parts described are each operably coupled together as necessary, one of ordinary skill in the art will understand how to connect general computer components, for example by use of a mother board or other computer board. In the shown embodiment the computer 100 includes a CPU 101. In one embodiment the CPU 101 includes only one processor. In other embodiments the CPU 101 may be made up of multiple processors. Different processors will allow for different computing power and speed.

The computer 100 includes at least one storage device 102. In different embodiments the at least one storage device 102 may be a solid-state storage device, a disk storage device, or another suitable storage device. One of ordinary skill in the art will recognize that there are several types of computing storage devices each providing well-known benefits and drawbacks. The at least one storage device 102 will store at least the computer operating system 102a and system software 102b. System software 102b may include any software necessary, or optionally, used to run any system described herein.

The computer 100 will have at least one memory device 103. One of ordinary skill in the art will recognize that there are several types of computing memory devices each providing well known benefits and drawbacks. The at least one memory device 103 will store at any active software 103a. Active software 103a may include the operating system 102a or parts of the system software 102b. The at least one memory device 103 may store the entire system software 102b size and speed permitting.

The computer 100 may also include various connection ports and types. The computer 100 may have a display adaptor 104. The display adaptor 104 will allow the computer 100 to connect to at least one display 105. In other embodiments multiple displays may be connected to the display adaptor 104. Similarly, the computer 100 may include at least one input/output interface 106. The input/output interface 106 will allow the computer 100 to connect to at least one system, referred to as System X 107 in FIG. 1. The input/output interface 106 may also allow for connection to only part of System X 107 or multiple systems. The computer 100 will also be operably connected to a required power source 108.

The computer 100 may also include a transceiver 109. In one embodiment the transceiver 109 is a wired transceiver. In another embodiment the transceiver 109 is a wireless transceiver. The transceiver 109 will allow the computer 100 to connect to a network 110. The network 110 may be an internet or an intranet connection. The network 110 will allow for the computer 100 to potentially connect to multiple other computing devices. In another embodiment the network may allow for the computer 100 to connect to multiple systems. In one embodiment the computer 100 will allow for System X 107 to be connected to the network 110.

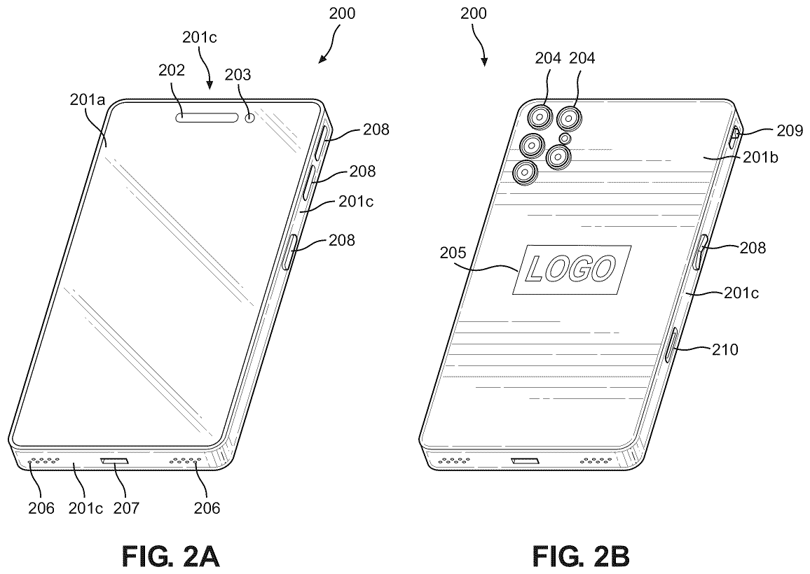

Referring now to FIG. 2A and FIG. 2B, there is shown a front view and a rear view of an example of an electronic device 200, such as a mobile phone device. Electronic devices may have many different parts and components. Even like parts or components may be in various locations or have different shapes and sizes. One of ordinary skill in the art will understand that the shown electronic device 200 is merely an example of the exterior of a device. Any specialized or specific features or requirements of devices will be detailed herein as necessary. However, one of ordinary skill in the art will understand that many electronic devices 200 have many of these described characteristics. Further, electronic devices, such as mobile phone devices, operate on a computer-based platform having many of the computer parts as described in FIG. 1. The below description seeks to detail external components and not the computer which runs the electronic device 200. The electronic device 200 can be, without limitation, a mobile phone device, or a tablet. In one embodiment other electronic devices may be used such as laptops, cable set top boxes, routers, or antennas.

The shown electronic device 200 includes a front surface 201a, a rear surface 201b, and four side surfaces 201c. The front surface 201a typically includes a screen which covers a majority of the surface. The screen is typically covered with a specialized material, currently a glass product. The front surface 201a may also include a speaker opening 202 and a camera opening 203.

The rear surface 201b of the electronic device 200 may include at least one camera lens 204. In the shown embodiment there are a plurality of camera lenses 204. In another embodiment at least one light lens is secured to the rear surface 201b. In many embodiments the rear surface 201b includes a logo 205. The logo 205 may represent the company which created the electronic device 200. The rear surface 201b may include a coating or covering to decorate or protect the rear surface. For example, a coating may be applied to the rear surface 201b to ensure a shiny surface.

The side surfaces 201c of the electronic device 200 may include any or all of the following parts. In one embodiment the electronic device 200 will have several openings for speaker output 206. The electronic device 200 will also include a charging port 207. Charging ports 207 may include a prong therein to secure to a charging cord. An electronic device 200 may include a plurality of buttons 208 along the side surfaces 201c. In different embodiments the plurality of buttons 208 may allow for volume control, locking the electronic device 200, or other desired functions. In some embodiments the electronic device 200 may include a switch 209. In yet another embodiment the electronic device 200 includes a SIM card slot or other card slot 210.

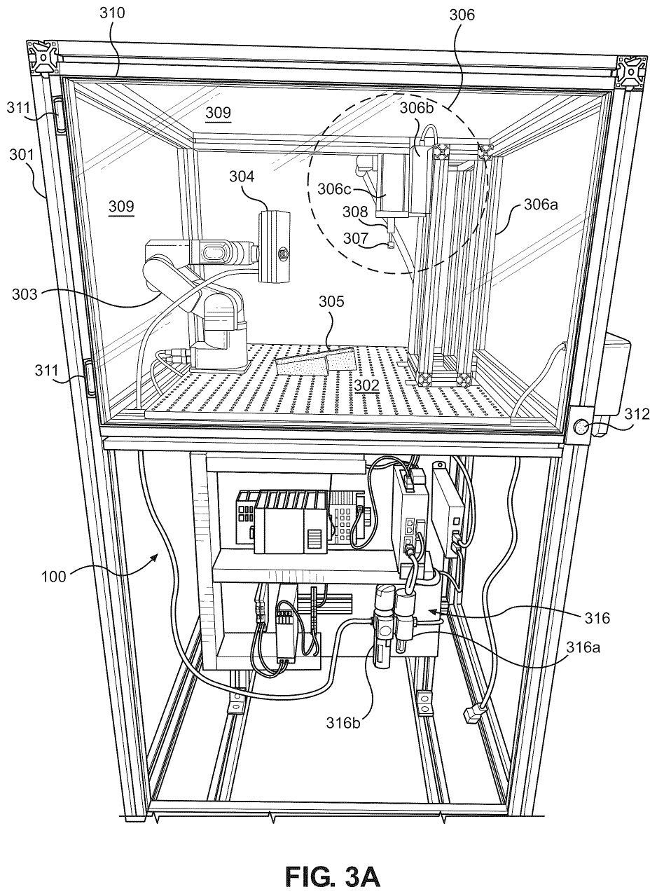

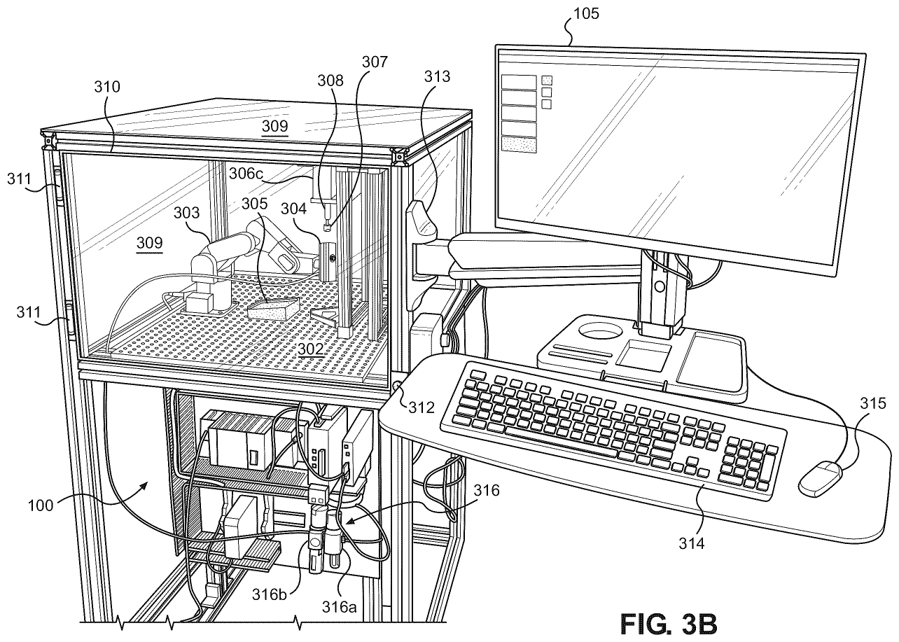

Referring now to FIG. 3A and FIG. 3B, there is shown several views of the electronic device mid-frame polishing apparatus. The apparatus includes a frame 301 which includes a plurality of both horizontal and vertical supports. The frame 301 supports at least one planar surface 302. The planar surface 302 is used to support several additional components.

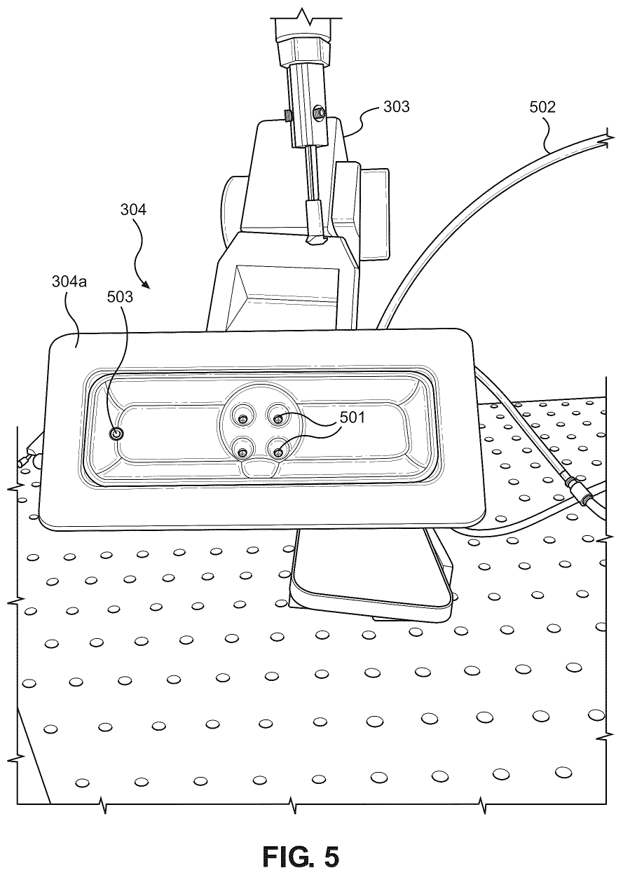

The additional components include a robot arm 303. In one embodiment the robot arm 303 is a multi-axis robot arm. The robot arm 303 is configured to have a tool head 304 secured thereto. The tool head 304 will be detailed in the description of FIG. 5. Further, the robot arm 303 is operably coupled to the computer 100.

The planar surface 302 is configured to secure a device holder 305 thereon. The device holder 305 is positioned between the robot arm 303 and a polishing setup 306 (to be further detailed below). This allows the robot arm 303 to pick up an electronic device and position it for polishing under the polishing setup 306.

In one embodiment the polishing setup 306 is comprised of a setup tower 306a. The setup tower 306a is used to support an actuator 306b. The actuator is operably coupled to the computer. In other embodiments different structures can be used in order to support the polishing setup 306 without departing from the spirit of the invention. The actuator 306b is secured to a motor 306c. The motor 306c is operably secured to the computer 100. The actuator 306b can then move the motor 306c up and down as direct by the computer 100.

The motor 306c is configured to have tool heads 307 secured to the rotating shaft 308 of the motor 306c. Tool heads 307 can be of different diameters which will allow for different polishing methods to be used. For example, a tool head 307 having a lessor diameter can be used to polish between the buttons of an electronic device. Further, the different tool heads 307 can have different grit values. Different grit can remove different amounts of materials to create a different polish results.

In some embodiments safety features can be included as part of the apparatus. In one embodiment protection walls or windows 309 can be secured to the frame 301. The protection walls 309 can prevent polishing debris from exiting the general work area. In one embodiment a door 310 can be secured to the frame 301 via at least one hinge 311. This will allow for the operator to be protected from any debris. In another embodiment an emergency stop button 312 is included. The emergency stop button 312 can be used to immediately stop the polishing apparatus no matter where in the process it is.

In the shown embodiment the computer 100 is stored below the planar surface 302. The computer 100 may be stored in various locations while still being capable of performing the needs of the present apparatus. In the shown embodiment the location allows for the computer 100 to be kept safely out of the way of an operator and kept clean from any polishing debris.

The screen 105 of the can be secured to the frame 301 via a screen mount 313. This will allow the screen 105 to be connected to the apparatus. In the embodiment shown, the screen mount 313 also supports a keyboard 314 and a mouse 315. This will enable a user to control the apparatus.

In some embodiments the tool head 304 secured to the robot arm 303 requires vacuum components 316. The vacuum components 316 include a vacuum pump 316a and a regulator 316b. In some embodiments the vacuum components 316 can be secured to the frame 301 in a manner similar to the computer.

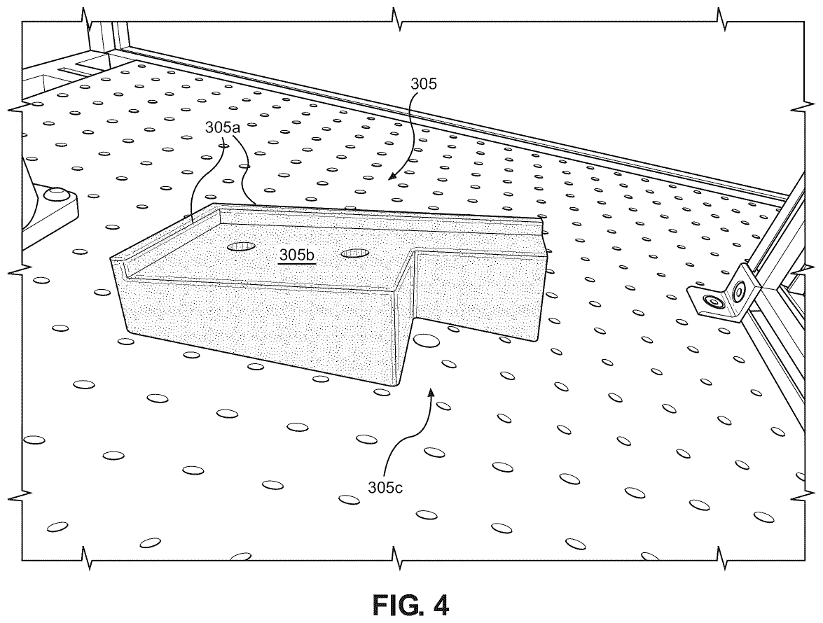

Referring now to FIG. 4, there is shown a side perspective view of a device holder for the electronic device mid-frame polishing apparatus. In different embodiments the device holder 305 may have different features. The main aspect of the device holder 305 is that it places the electronic device in a position where the robot arm can pick up the device. In some embodiments the device holder 305 may be as simple as a colored outline.

Accuracy can be important in the polishing process and therefore the more accurate of a location the electronic device is placed in the more precisely the robot arm can pick up and move the electronic device to the polishing setup. In the shown embodiment the device holder 305 includes at least two sidewalls 305a. The at least two sidewalls 305a can allow for the edges of the electronic device to be placed such that a corner can be placed snuggle against the junction of the two sidewall 305a. The sidewalls 305a rise from the perimeter of a planar surface 305b of the device holder 305.

In one embodiment the planar surface 305b can be angled such that it angles down and toward the corner of the at least two sidewalls 305a. In some embodiments electronic devices have cameras, lenses or lights which protrude from the back of the electronic device. In order to account for these items in some embodiments the device holder 305 can have a cut away section 305c. This will allow for the protrusions to sit in the cut away section 305c and the remainder of the electronic device to sit flush with the planar surface 305b.

Referring now to FIG. 5, there is shown a front view of an embodiment of the electronic device holder for the electronic device mid-frame polishing apparatus. In one embodiment the tool head 304 which is secured to the robot arm 303 is a vacuum attachment. In this embodiment the tool head 304 has a seal 304a about the perimeter of the tool head 304. This seal 304a can secure to an electronic device so that the tool head 304 can pick up and support the electronic device. In the shown embodiment the tool head 304 is secured to the robot arm 303 via a plurality of screws 501. The tool head 304 has a vacuum tube 502 connected thereto. The vacuum tube 502 is coupled such that there is an aperture 503 through which a vacuum can be created.

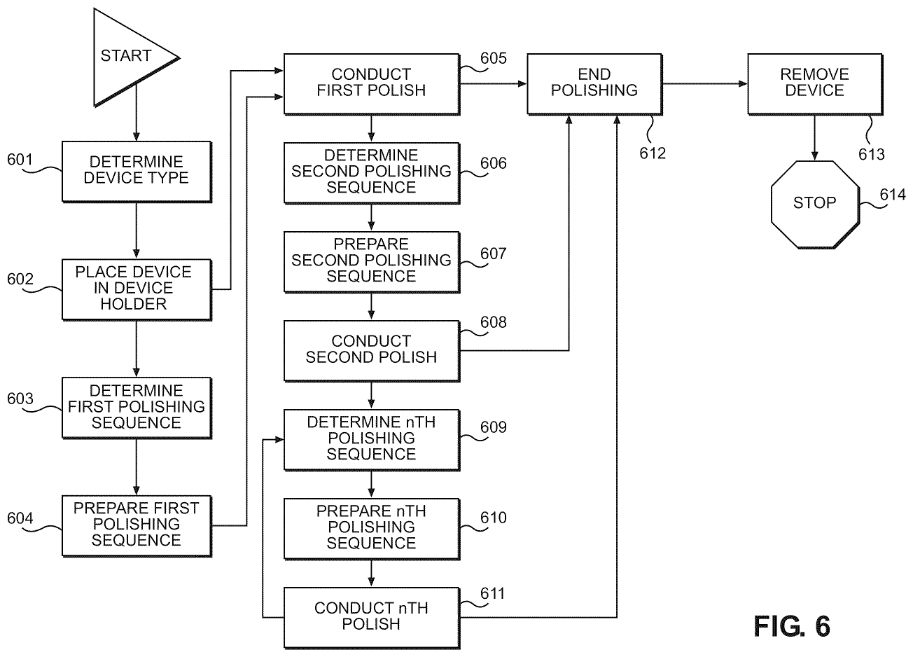

Referring now to FIG. 6, there is shown a flow chart of one embodiment of a method for using the electronic device mid-frame polishing apparatus. The method of using the polishing apparatus begins by determining the type of the electronic device. 601. The device type may include information such as make, model, and color. The determination of device type may not be necessary in some embodiments. In embodiments where different types of electronic devices are to be polished different polishing sequences (discussed below) may be needed. Therefore, in an embodiment where the apparatus is configured to only polishing one type of device the determination step 601 will not be needed.

After the device type is determined 601 the electronic device should be placed in the device holder 602. After the device has been properly placed in the device holder the first polishing sequence should be determined 603. In one embodiment where there is only one polishing sequence the method can skip directly to conducting the first polishing sequence 605. Once the first polishing sequence has been determined the sequence may need to be prepared for. 604.

After the first polish has been conducted 605 the polishing may end 612 or a second polishing sequence may be determined 606. The second polishing sequence may need to be prepared 607. After preparation the second polishing sequence should be conducted 608. In one embodiment after the second polishing sequence is completed 608 the polishing ends 612. In another embodiment the method continues to determining the n^{th} polishing sequence 609. The n^{th} polishing sequence should then be prepared for 610 and conducted 611. After the last of the n^{th} polishing sequences have been conduced the polishing ends 612. The electronic device can then be removed 613 and the method ends 614.

For clarity and completeness of description the determination of polishing sequence steps can include items such as, but not limited to, determining a polishing path, determining a force to be applied, and determining a length of polish time. The preparing for the polishing sequence may include changing the tool head 307 as needed. Further, this step may include adding a polishing medium to the electronic device or the tool head 307.

It is therefore submitted that the methods, systems, and devices have been shown and described in what is considered the most practical and preferred embodiments along with specific examples. It is recognized, however, that departures may be made within the scope and these present examples are not intended to be limiting. One of ordinary skill the art will be able to discern that obvious modifications can be made without departing from the scope or spirit.

With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention. Similarly, it is to be realized that, it is not intended for any method set forth herein to be construed as requiring that its steps be performed in a specific order, unless otherwise set forth in the claims.

Therefore, the foregoing is considered as illustrative only of the principles of the disclosure. Further, since numerous modifications and changes will readily occur to those skilled in the art, it is not desired to limit the invention to the exact construction and operation shown and described, and accordingly, all suitable modifications and equivalents may be resorted to, are deemed to fall within.

What is claimed:

1. An electronic device mid-frame polishing apparatus, the apparatus comprising:
a frame which supports a robot arm and a polishing setup;
wherein the robot arm is configured to place an electronic device into the polishing setup;
the frame supports at least one computer;
the robot arm is operably coupled with the computer;
the polishing setup is operably coupled with the computer.

2. The electronic device mid-frame polishing apparatus of claim 1, further comprising a planar surface, wherein the robot arm and the polishing setup are mounted to the planar surface.

3. The electronic device mid-frame polishing apparatus of claim 2, further comprising a device holder mounted to the planar surface.

4. The electronic device mid-frame polishing apparatus of claim 3, wherein the device holder is positioned within reach of the robot arm.

5. The electronic device mid-frame polishing apparatus of claim 3, wherein the device holder is comprised of a planar surface having a plurality of sidewalls rising therefrom;
Wherein the planar surface has at least one cutaway section.

6. The electronic device mid-frame polishing apparatus of claim 1, wherein the robot arm has a toolhead attached to one end.

7. The electronic device mid-frame polishing apparatus of claim 6, wherein the tool head is a vacuum assembly configured to pick up and hold an electronic device.

8. The electronic device mid-frame polishing apparatus of claim 1, wherein the polishing setup is comprised of an actuator, a motor, and a tool head.

9. The electronic device mid-frame polishing apparatus of claim 1, further comprising a vacuum pump and a vacuum regulator secured to the frame.
